(19) United States
(12) Patent Application Publication
(10) Pub. No.: US 2011/0078181 A1
(43) Pub. Date: Mar. 31, 2011

(54) COMMUNICATION DEVICE

(75) Inventor: Yasuyuki MITSUMORI, Kawasaki (JP)

(73) Assignee: FUJITSU LIMITED, Kawasaki-shi (JP)

(21) Appl. No.: 12/894,473

(22) Filed: Sep. 30, 2010

(30) Foreign Application Priority Data
Sep. 30, 2009 (JP) 2009-226332

(51) Int. Cl. G06F 17/30

(52) U.S. Cl. 707/769; 707/E17.014

(57) ABSTRACT

A communication device includes: an entry search information storage unit to store entry flag information indicating a type of an entered frame and entry search information having entry control information as control information of the entered frame, a flag generating unit to generate frame flag information indicating a type of a frame received by the communication device based on frame control information of the received frame, a search key generating unit to generate search key information having all or part of the frame flag information and of the frame control information of the received frame, and a search control unit to control the entry search information storage unit, compare the frame flag information of the search key information to the entry flag information of the entry search information, and search the entry search information having a corresponding comparison result by the frame control information of the search key information.

### CROSS-REFERENCE TO RELATED APPLICATIONS

This application is based upon and claims the benefit of priority from the prior Japanese Patent Application No. 2009-226332 filed on Sep. 30, 2009, the entire contents of which are incorporated herein by reference.

### FIELD

The embodiments discussed herein are related to a communication device which processes an input data frame.

### BACKGROUND

In recent years, demand is increasing for a network using an Ethernet® technique in a carrier network of a communication provider or the like. In the network using an Ethernet frame, a Virtual Local Area Network (VLAN) technique as a virtual sub-network is widely used, and a method for identifying a user (a customer) or a service of a carrier by using a VLAN tag is used in general. A VLAN tag of an Ethernet frame transmitted and received in the VLAN includes information indicating a type of the frame such as a Tag Protocol Identifier (TPID), a VLAN ID, and the like. And, an Ethernet frame may include a plurality of VLAN tags successively stacked by using a plurality of VLAN tags.

An associative memory and an associate memory may be used for an entry of the Ethernet frame using a plurality of VLAN tags in a communication device that transfers the Ethernet frame. To register the entry of the Ethernet frame that includes a plurality of stages of VLAN tags in the associative memory, if a one-stage tag frame, which has one stage of the VLAN tag, or a two-stage tag frame is received, for example, 20 bytes are extracted from the head part of the received frame, and a search key is generated by combining the extracted part with a reception port number.

However, before the entry of the one-stage tag frame or the entry of the two-stage tag frame is determined to correspond to the search key of the received frame, the entry of the frame with no tag masked (or filtered) except for the reception port number may be compared to the search key of the received frame. When this happens, the entry is mistakenly determined to correspond to the search key, which does not originally correspond to the entry. As a result, appropriate search may not be performed. In the same manner, if the search key of the frame, which is to be determined to have a two-stage tag, is compared to the frame with the one-stage tag of which the entry is stored in a position in which the determination is performed earlier, the search key may be mistakenly determined to correspond to the entry.

To prevent this, an entry configuration of the associative memory is configured in such a way that the entries are arranged and stored in the order of the two-stage tag entry, the one-stage tag entry, and the entry of the frame with no tag so that an entry with a smaller mask area and a larger area other than the mask area that is to be searched is allocated in an address with a smaller number, and an entry with a larger mask area is allocated in an address with a larger number. It is desirably determined whether or not the entry corresponds to the search key in the order of the two-stage tag entry, the one-stage tag entry, and the entry of the frame with no tag. As described above, the address order is considered in setting the entry of the associative memory of the communication device.

The conventional techniques are disclosed in Japanese Laid-open Patent Publication No. 2004-159019 and Japanese Laid-open Patent Publication No. 2008-227695.

### SUMMARY

According to an aspect of the invention, a communication device includes: an entry search information storage unit to store entry flag information indicating a type of an entered frame and entry search information having entry control information as control information of the entered frame, a flag generating unit to generate frame flag information indicating a type of a frame received by the communication device based on frame control information of the received frame, a search key generating unit to generate search key information having all or part of the frame flag information and of the frame control information of the received frame, and a search control unit to control the entry search information storage unit, compare the frame flag information of the search key information to the entry flag information of the entry search information, and search the entry search information having a corresponding comparison result by the frame control information of the search key information.

The object and advantages of the invention will be realized and attained by at least the features, elements, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 illustrates a first embodiment,

FIG. 2 illustrates an entire configuration of a communication system according to a second embodiment,

FIG. 3 illustrates a hardware configuration of a switch according to the second embodiment,

FIG. 4A illustrates a data configuration example 1 according to the second embodiment,

FIG. 4B illustrates another data configuration example 1 according to the second embodiment,

FIG. 4C illustrates another data configuration example 1 according to the second embodiment,

FIG. 5 is a block diagram illustrating a function of the switch according to the second embodiment,

FIG. 6 is a data configuration example of an entry search table according to the second embodiment,

FIG. 7 is a data configuration example of a destination table according to the second embodiment,

FIG. 8 is a flowchart illustrating a procedure of flag generating processing according to the second embodiment,

FIG. 9 is a block diagram illustrating a function of a switch according to a third embodiment,

FIG. 10 is a data configuration example of an entry search table according to the third embodiment,

FIG. 11 is a flowchart illustrating a procedure of flag generating processing according to the third embodiment,

FIG. 12 is a block diagram illustrating a function of a switch according to a fourth embodiment,

FIG. 13 is a data configuration example of a TPID setting table according to the fourth embodiment,

FIG. 14 is a flowchart illustrating a procedure of flag generating processing according to the fourth embodiment,

FIG. 15 is a block diagram illustrating a function of a switch according to a fifth embodiment,

FIG. 16 is a data configuration example of an entry search table according to the fifth embodiment, and

FIG. 17 is a data configuration example of a destination table according to the fifth embodiment.

### DETAILED DESCRIPTION OF THE PREFERRED EMBODIMENTS

In general, the above-described communication device frequently performs adding and deleting of entries such as registering an entry of a new user frame or deleting an entry of an unnecessary user frame. Therefore, to properly determine each entry of the frame with no tag, the entry of the one-stage tag frame, and the entry of the two-stage tag frame as examples of type of the frame, software typically performs sorting (rearranging) of the entries to maintain an appropriate arrangement of the entries in the address according to addition or deletion of entries of each frame. The above-described processing, which is complicated for software and a Central Processing Unit (CPU), is high-load processing. If the number of entries to be stored is large, it takes time until the appropriate rearrangement of the entries is completed. Accordingly, in some cases, the load of the processing may increase or the time required for registration of the entry may increase, which may cause a delay or termination of communication.

With reference to the diagrams, embodiments will be described below.

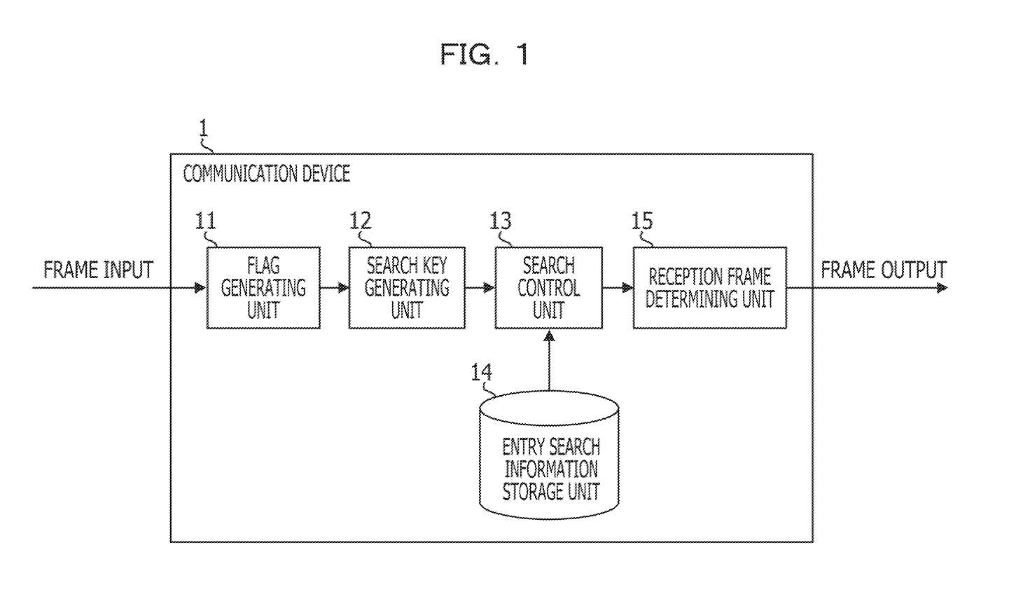

FIG. 1 is a diagram illustrating a first embodiment. A communication device 1 illustrated in FIG. 1 includes a flag generating unit 11, a search key generating unit 12, a search control unit 13, and an entry search information storage unit 14. The communication device 1 further includes a reception frame determining unit 15 that determines a transfer destination of a frame received according to a search result by the search control unit 13.

The communication device 1 receives data such as a frame, a packet, and the like transmitted from a terminal device (not illustrated) that is used by a user, and performs transferring processing based on control information such as address information and the like stored in the data. For example, to transfer an Ethernet frame or an IP frame transmitted from the terminal device, the communication device 1 performs processing for transferring the Ethernet frame or the IP frame based on a Media Access Control (MAC) address stored in the Ethernet frame, an Internet Protocol (IP) address stored in the IP frame, or the like. The data is divided and is then transferred in a network to which the communication device 1 is coupled. Specifically, if the communication device 1 is a Layer 2 (L2) switch, the divided data is a frame. If the communication device 1 is a Layer 3 (L3) switch, the divided data is a packet. In the present embodiment, description is made of a frame as data to be transferred. The data to be transferred is not limited to the frame. The data to be transferred may be a packet or data that is not divided.

The flag generating unit 11 generates frame flag information that indicates a type of the frame received based on frame control information of the received frame. The search key generating unit 12 generates search key information that includes all or a part of the frame flag information generated by the flag generating unit 11 and of the frame control information of the received frame.

The search control unit 13 controls the entry search information storage unit 14 and compares the frame flag information of search key information to entry flag information of entry search information, and searches the entry search information having a corresponding comparison result by the frame control information of the search key information.

The entry search information storage unit 14 stores the entry flag information, which indicates a type of the entered frame, and the entry search information that includes the entry control information as the control information of the entered frame.

In this manner, the communication device 1 checks the type of the received frame and generates the frame flag information according to the type of the received frame. Then the frame flag information is included in a search key that searches the entry. Furthermore, the entry includes the entry flag information indicating a type of the frame. The entry flag information is used to perform searching processing. Accordingly, since an entry to be searched may be specified by the entry flag information and the frame flag information, an address order of the entry is not required to be considered. This makes it possible to set an arbitrary entry to an arbitrary address, so that sorting the entries becomes unnecessary.

The above-described communication device will be described more specifically below. In the following embodiments, the communication device is described as a switch. The L2 switch that relays a frame of a data link layer based on a MAC address will be described. The communication device is not limited to the L2 switch. The present embodiment may be applied to an IP router or the L3 switch, for example, as a communication device relaying a packet in a network layer based on the IP address. A data unit of the L2 of an Open Systems Interconnection (OSI) reference model may be called a “packet.” In the following embodiments, however, the unit is referred to as a frame for convenience in the description.

### Second Embodiment

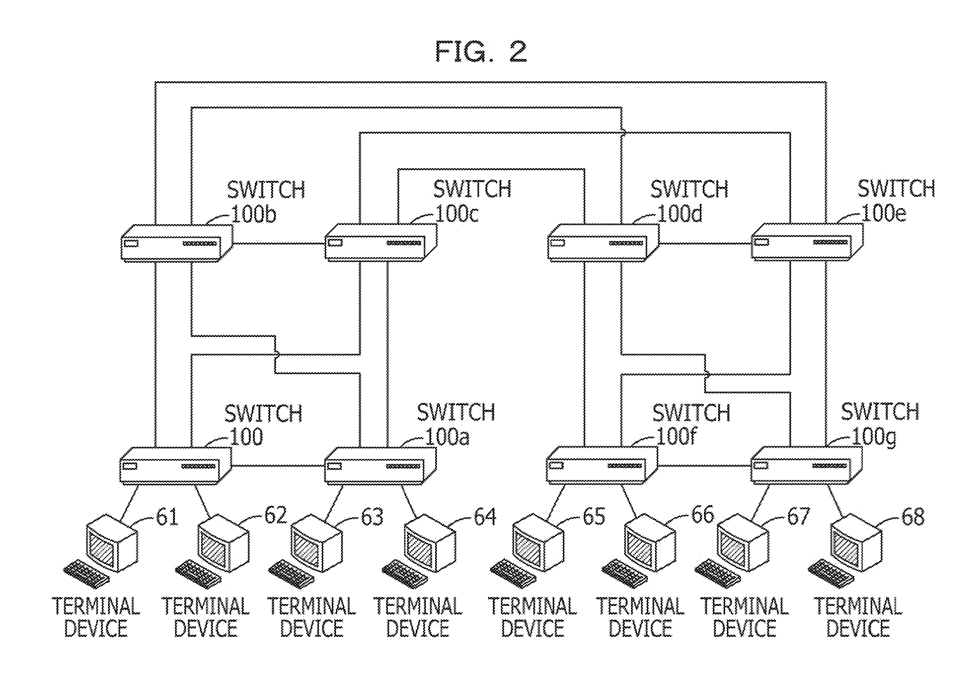

A second embodiment will be described. FIG. 2 is a diagram illustrating an entire configuration of a communication system according to the second embodiment. In the communication system according to the second embodiment, a plurality of L2 switches relays a frame of a data link layer so that data may be transmitted and received between terminal devices.

The communication system illustrated in FIG. 2 includes switches 100, 100a, 100b, 100c, 100d, 100e, 100f, and 100g, and terminal devices 61, 62, 63, 64, 65, 66, 67, and 68. The switches 100, 100a, 100b, 100c, 100d, 100e, 100f, and 100g are L2 switches. The terminal devices 61, 62, 63, 64, 65, 66, 67, and 68 are terminal devices used by a user. The switches 100a, 100b, 100c, 100d, 100e, 100f, and 100g are configured similarly to the switch 100 and have substantially the same function equivalent to the switch 100.

The switch 100 is coupled to the switches 100a, 100b, and 100c. The switch 100a is coupled to the switches 100, 100b, and 100c. The switch 100b is coupled to the switches 100, 100a, 100c, 100d, and 100e. The switch 100c is coupled to the switches 100, 100a, 100b, 100d, and 100e. The switch 100d is coupled to the switches 100b, 100c, 100e, 100f, and 100g. The switch 100e is coupled to the switches 100b, 100c, 100d, 100f, and 100g. The switch 100f is coupled to the switches 100d, 100e, and 100g. The switch 100g is coupled to the switches 100d, 100e, and 100f.

The terminal devices 61 and 62 are coupled to the switch 100. The terminal devices 63 and 64 are coupled to the switch 100a. The terminal devices 65 and 66 are coupled to the switch 100f. The terminal devices 67 and 68 are coupled to the switch 100g. One or more physical links (network cables) are used to couple a switch with another switch or couple a switch with a terminal device.

According to an address included in the frame, the switches 100, 100a, 100b, 100c, 100d, 100e, 100f, and 100g relay the frame from a terminal device at a source to a terminal device at a destination. Specifically, when the terminal device 61 relays the frame to the terminal device 68, the frame is relayed by the switches in the order of the switches 100, 100c, 100d, and 100g, for example.

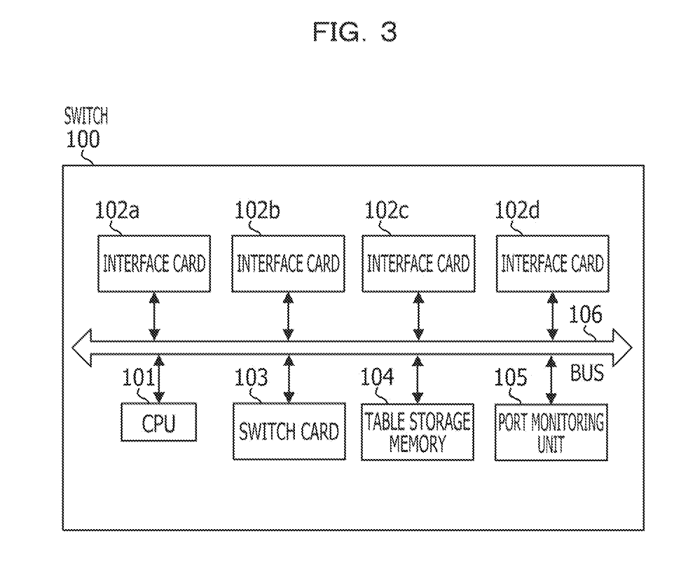

FIG. 3 is a diagram illustrating a hardware configuration of a switch according to the second embodiment. FIG. 3 illustrates an internal configuration of the switch 100. The switches 100a, 100b, 100c, 100d, 100e, 100f, and 100g may be realized by substantially the same configuration equivalent to the switch 100. The switch 100 includes a CPU 101, interface cards 102a, 102b, 102c, and 102d, a switch card 103, a table storage memory 104, a port monitoring unit 105, and a bus 106.

The CPU 101 controls the entire switch 100. The CPUT 101 performs processing by a program. The CPU 101 uses the data stored in a memory (not illustrated) and performs the program stored in the memory. The CPU 101 receives a command transmitted from a management terminal device (not illustrated) used by an administrator through a communication interface (not illustrated) and replies a performance result to the management terminal device in response to the command.

The table storage memory 104 stores a plurality of tables. The tables stored in the table storage memory 104 are a table for managing a configuration of a logical link, a table for deciding a transfer destination of a frame in the logical link, and a table for storing information indicating the transfer destination of the frame.

The bus 106 is coupled to the CPU 101, the interface cards 102a, 102c, and 102d, the switch card 103, the table storage memory 104, and the port monitoring unit 105.

Each of the interface cards 102a, 102b, 102c, and 102d includes a plurality of communication ports (for example, eight communication ports). Each of the communication ports may be coupled to one physical link. The interface cards 102a, 102b, 102c, and 102d monitor each of the communication ports and obtain the frame, respectively. Each of the interface cards 102a, 102b, 102c, 102d includes a buffer that temporally stores a frame inside the respective cards in case the frames arrive at a plurality of communication ports at a time. Then each of the interface cards 102a, 102b, 102c, and 102d transmits the obtained frame to the switch card 103.

The switch card 103 includes a table indicating destinations of a frame. The switch card 103 stores, in the table, a source address of the received frame in association with identification information of the communication port at which the frame arrives, or identification information of the logical link. Contents of this table are statically set in advance.

If the switch card 103 receives the frame from any of the interface cards 102a, 102b, 102c, and 102d, the switch card 103 decides a transfer destination of the frame with reference to the table. In this case, if the decided transfer destination is a logical link, the switch card 103 decides the interface cards 102a, 102b, 102c, and 102d, and a communication port which are to be specifically used for the transfer, with reference to the table stored in the table storage memory 104. After that, the switch card 103 transmits the frame to the decided interface cards 102a, 102b, 102c, and 102d.

After receiving the frame, the interface cards 102a, 102b, 102c, and 102d transmit the frame to a destination from the decided communication port. The port monitoring unit 105 monitors the communication ports of the interface cards 102a, 102b, 102c, and 102d. When detecting a failure or a recovery of a physical link coupled to the communication ports of the interface cards 102a, 102b, 102c, and 102d, the port monitoring unit 105 reports the failure or the recovery of the physical link to the CPU 101.

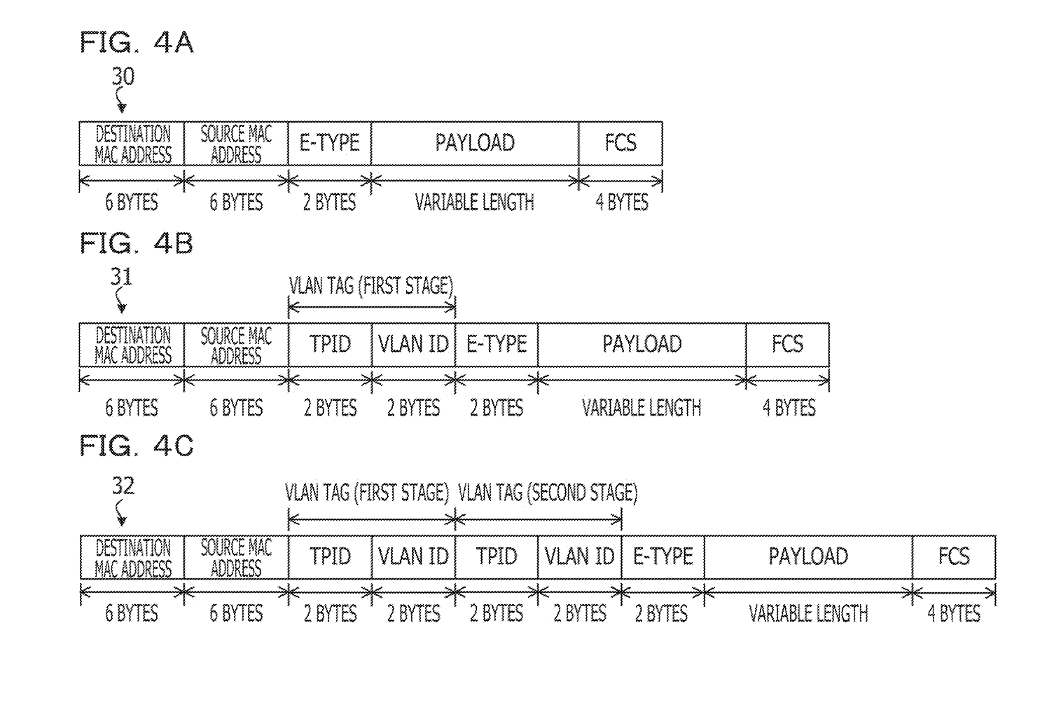

FIGS. 4A, 4B, and 4C are diagrams illustrating a data configuration example of a frame according to the second embodiment. A frame 30 illustrated in FIG. 4A, a frame 31 illustrated in FIG. 4B, and a frame 32 illustrated in FIG. 4C are transmitted and received to/from the switch 100 or the like through the communication ports of the interface cards 102a, 102b, 102c, and 102d.

The frame 30 is a frame with no tag that has no VLAN tag. The frame 31 is a one-stage tag frame that has a one-stage VLAN tag. The frame 32 is a two-stage tag frame that has a two-stage VLAN tag. The above-described frames 30 to 32 may be mixed in substantially the same physical port in the switch 100 and then be transferred.

The frame 30 includes a Media Access Control address Destination Address (MAC DA), a source Media Access Control address, an EtherType (E-TYPE), a payload, and a Frame Check Sequence (FCS). The frames 31 and 32 further include a one-stage VLAN tag and a two-stage VLAN tag, respectively.

The destination MAC address uniquely identifies a communication interface of the terminal device at the destination. The source MAC address uniquely identifies a communication interface of the terminal device at the source. The VLAN tag includes a TPID and a VLAN ID. As described in the frame 32 illustrated in FIG. 4C, a plurality of VLAN tags are successively stacked. The E-TYPE is a field that specifies a protocol to be used. The E-TYPE stores a message type that is stored in a payload in a later stage. For example, 0x0800 indicates an IPv4 frame. The payload stores a message of an upper layer such as the IPv4 frame. For example, the payload, which is a data body to be transmitted and received, is obtained by dividing an IP packet into a prescribed data length. The FCS is a value that is used to detect an error of the received frame.

The TPID is a value that indicates that the VLAN ID is stored in the later stage and indicates a type of the frame (for example, a frame of the VLAN or a regular frame). For the TPID, 0x8100 specified in IEEE802.1q is generally set. The VLAN ID is a value that is uniquely specified to be allocated to each logical network when one network is divided into a plurality of logical networks to be operated. The VLAN ID stores, for example, a VLAN ID value used to specify a user.

In a physical port of the Ethernet of the switch 100 in which various frames illustrated in FIGS. 4A, 4B, and 4C are mixed, the frame with no tag (the frame 30) is generally used as a frame for a specific user or is used as a control frame that is transmitted and received between switches.

The frame (the frames 31 and 32) with a VLAN tag stores the VLAN ID used to identify a user in the VLAN ID field. For example, VLAN ID=100 may be allocated to a user A, and VLAN ID=200 may be allocated to a user B. As described above, by allocating different VLAN IDs to different users, the users may be identified by the VLAN IDs on a network.

The two-stage tag frame (the frame 32) is used when a frame of a lower network is transferred in an upper network. In general, the VLAN tag in the second stage is used as a tag used to identify a user in the lower network or as a management tag. Furthermore, in general, the VLAN tag in the first stage is used as a tag used to identify a user in the upper network or as a management tag.

In this case, a VLAN tag (for example, the VLAN tag in the second stage of the frame 32) for the upper network management is newly added as an outside tag at an entrance point of the upper network from the lower network. At an exit point from the upper network to the lower network, the outside tag added as the VLAN tag for the upper network management is deleted.

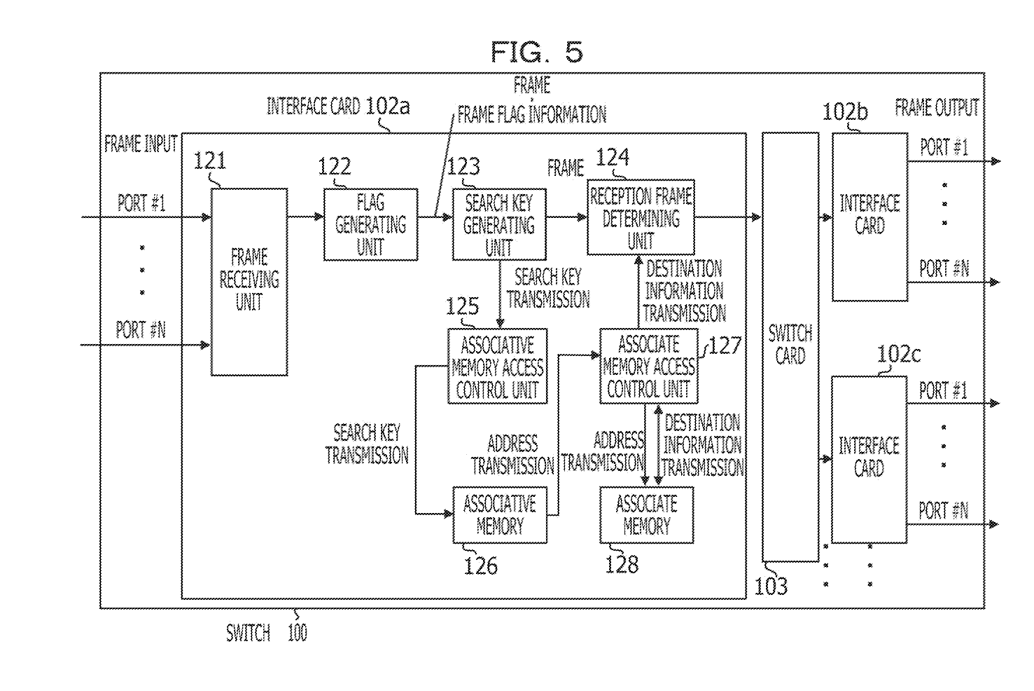

The configuration of the frame is variable according to an operation form of the network, international standards, and the like. Header information other than as illustrated in FIGS. 4A, 4B, and 4C may be added. FIG. 5 is a block diagram illustrating a function of a switch according to the second embodiment. FIG. 5 illustrates the switch 100. Moreover, the switches 100a, 100b, 100c, 100d, 100e, 100f, and 100g may be realized by substantially the same function equivalent to the switch 100.

FIG. 5 illustrates an operation of the switch 100 of a case where the frame is received by the interface card 102a and is transferred by the ports #1 to #N of the interface cards 102b, 102c, etc., through the switch card 103.

The interface card 102a includes a frame receiving unit 121, a flag generating unit 122, a search key generating unit 123, a reception frame determining unit 124, an associative memory access control unit 125, an associative memory 126, an associate memory access control unit 127, and an associate memory 128.

The interface card 102a includes a line port (for example, the port #1) used to communicate with another coupled communication device or a communication apparatus such as a terminal device, has an interface function with a communication apparatus, and provides reception frame processing, transmission frame processing, and the like. The interface card 102a may be detachably attached to the switch 100 or combined with the switch 100 or a motherboard of the switch 100.

The frame receiving unit 121 terminates a physical layer and a MAC layer of each reception port (for example, the ports #1 to #N) of the interface card 102a. In the MAC layer, the FCS check of the received frame and the like are performed. The frame in which an FCS error is detected is rejected, and the frame in which no error is detected is received. The above-described frame is user data that is transferred by statistical multiplexing using the network coupled to the switch 100.

Based on the frame control information of the received frame, the flag generating unit 122 generates the frame flag information as flag information indicating a type of the received frame. The frame flag information indicates the presence and the number of the VLAN tags of the received frame. If the value of an area where the TPID of the received frame is set corresponding to a prescribed value, the flag generating unit 122 determines that the received frame has the VLAN tag, and then generates the frame flag information. The flag generating unit 122 checks the number of tag stages of the VLAN tag of the received frame, and then determines the value of the frame flag information according to the number of tag stages. The generated frame flag information is transmitted with the received frame to the search key generating unit 123.

The search key generating unit 123 generates the search key information that has all or a part of the frame flag information generated by the flag generating unit 122 and of the frame control information of the received frame.

The search key generating unit 123 obtains control information from the received frame. At this time, the search key generating unit 123 obtains the control information by extracting 20 bytes of data from the head to the 20th byte of the received frame, combines the obtained control information with the frame flag information and the port number received from the flag generating unit 122, and then transmits the combination as a search key of the associative memory 126 to the associative memory access control unit 125.

Based on a result of the above-described search, the reception frame determining unit 124 performs control of the frame received by the frame receiving unit 121 such as determination of a destination, determination of rejection, or the like. The reception frame determining unit 124 determines a destination of the frame that is received based on the destination information transmitted from the associate memory access control unit 127. If a reception valid flag of the destination information indicates that the reception of the received frame is rejected, the reception frame determining unit 124 rejects the received frame.

The associative memory access control unit 125 performs arbitration control of the search with respect to the associative memory 126 transmitted from the search key generating unit 123 and of the access to the associative memory 126 from the CPU 101.

The associative memory access control unit 125 controls the associative memory 126, compares the frame flag information of the search key information to the entry flag information of the entry search information, and searches the entry search information having the corresponding comparison result by comparing the entry control information of the entry search information to the frame control information of the search key information. The associative memory access control unit 125 functions as a search control unit.

The associative memory 126 stores the entry flag information as the flag information indicating a type of the entered frame and stores the entry search information that includes the entry control information as the control information of the entered frame. The entry flag information indicates the presence and the number of the VLAN tags of the entered frame. The associative memory 126 performs the search by the search key transmitted from the associative memory access control unit 125. If a corresponding entry is searched, the address in which the entry is stored is transmitted to the associate memory access control unit 127. The entry of the associate memory 128 may be read by the above-described transmitted address as an index. The associative memory 126 functions as an entry search information storage unit. The associative memory 126 is used in the present embodiment. However, the storage device is not limited to the associative memory 126. The associative memory 126 is, for example, a Content-addressable memory (CAM) or a Ternary CAM (TCAM). Storage devices in other systems such as a Static Random Access Memory (SRAM) may be used.

The associate memory access control unit 127 performs the arbitration control of the access from the associative memory 126 and control of the access to the associate memory 128 from the CPU 101. Moreover, the associate memory access control unit 127 transmits, to the reception frame determining unit 124, the destination information of the received frame stored in the associate memory 128 according to the entry search information that is searched from the associative memory 126 by a sequence of the searching processing. The associate memory access control unit 127 functions as a destination control unit.

The associate memory 128 stores the destination information indicating a destination of the received frame. The destination information includes the reception valid flag indicating whether the reception of the received frame is permitted or rejected. The associate memory 128 functions as a destination information storage unit. The associate memory 128 includes the SRAM. However, the storage device is not limited to the SRAM. Storage devices in other systems such as a Dynamic Random Access Memory (DRAM) or the like may be used.

The interface cards 102b, 102c, etc., are configured similarly to the interface card 102a and have substantially the same function equivalent to the interface card 102a. Based on the determination result of the reception frame determining unit 124, the switch card 103 transfers the user frame from the interface card by which the user frame was received to the interface card by which the user frame is to be transmitted. Based on this, the frame is output from the port of the interface card by which the frame was transferred. In the switch 100, the switch card 103 is coupled to the interface card 102a or the like by a data signal and switches a frame transfer between the interface card 102a and the interface card 102b, 102c, etc. The switch card 103 may be detachably attached to the switch 100, or combined with the switch 100 or the motherboard of the switch 100.

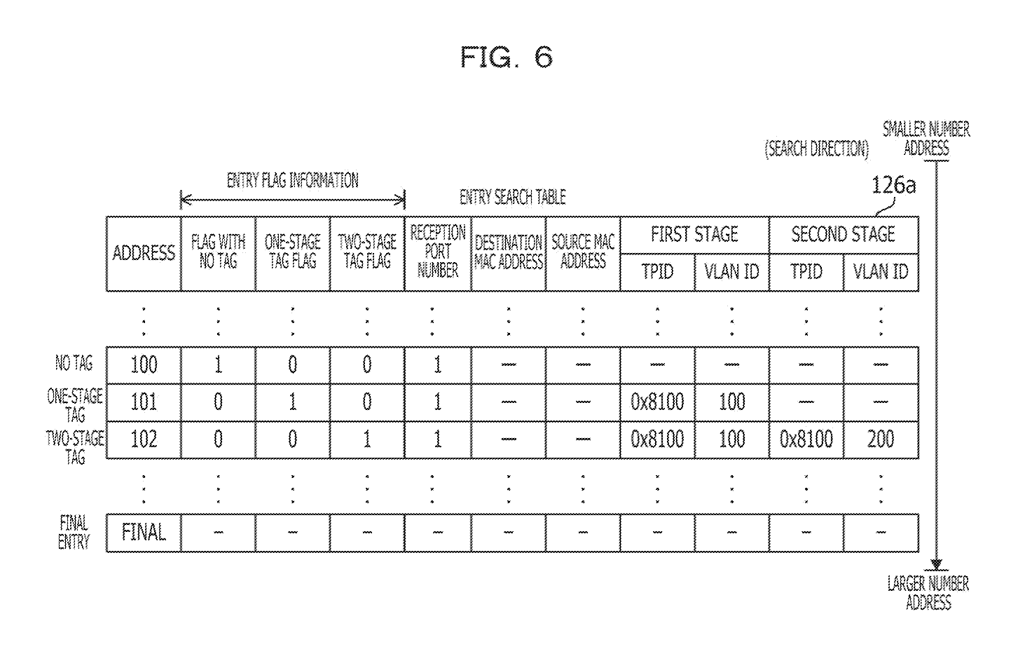

FIG. 6 is a diagram illustrating a data configuration example of an entry search table according to the second embodiment. The entry search table 126a illustrated in FIG. 6 illustrates the configuration of the entry of the frame received by the switch 100, which is stored in the associative memory 126. The entry search table 126a stores the entry search information indicating a search condition of each entry compared to the search key of the frame received by the switch 100. The entry search table 126a includes an “address,” a “flag with no tag” field, a “one-stage tag flag” field, a “two-stage tag flag” field, a “reception port number” field, a “destination MAC address” field, a “source MAC address” field, a “TRID” field (the first stage), a “VLAN ID” field (the first stage), a “TRID” field (the second stage), and a “VLAN ID” field (second stage). The information arranged in a transverse direction of the fields correspond +− to each other as the entry search information.

The “address” is an address in which each of the entry search information of the associative memory 126 is stored. The “flag with no tag” field, the “one-stage tag flag” field, and the “two-stage tag flag” field indicate areas of one bit in which the entry flag information indicating the presence and the number of VLAN tags as a search condition of the entry is set. If the frame of the entry has no tag, “1” is set to the flag with no tag. If the frame of the entry has a one-stage tag, “1” is set to the one-stage tag flag. If the frame of the entry has a two-stage tag, “1” is set to the two-stage tag flag.

The “reception port number” field is a 1-byte area indicating the reception port number in which the frame as the search condition of the entry is received. The “destination MAC address” field is a 6-byte area indicating the destination MAC address indicated in the frame received by the switch 100 as the search condition of the entry. The “source MAC address” field is a 6-byte area indicating the source MAC address indicated in the frame received by the switch 100 as the search condition of the entry. The “TPID” field (the first stage) is a 2-byte area indicating the value of the TPID of the VLAN tag in the first stage as the search condition of the entry. The “VLAN ID” field (the first stage) is a 2-byte area indicating the value of the VLAN ID of the VLAN tag in the first stage as the search condition of the entry. The “TPID” field (the second stage) is a 2-byte area indicating the value of the TPID of the VLAN tag in the second stage as the search condition of the entry. The “VLAN ID” field (the second stage) is a 2-byte area indicating the value of the VLAN ID of the VLAN tag in the second stage as the search condition of the entry.

According to the present embodiment, in the entry search table 126a illustrated in FIG. 6, the first 3 bits indicates the entry flag information of the “flag with no tag” field, the “one-stage tag flag” field, and the “two-stage tag flag” field respectively, and the following 1 byte indicates the reception port number. The remaining 20 bytes (from the destination MAC address field to the VLAN ID field in the second stage) correspond to the 20 bytes of data from the head of the frame received by the switch 100. For the frame received by the switch 100, search of the frame from the entry flag information of each entry and the destination MAC address field to the VLAN ID field (the second stage) indicated in the entry search table 126a is performed by comparing the flag generated by the flag generating processing to the 20-byte data search key extracted from the head.

In the entry search table 126a, “-” indicates a masked area. The masked area indicates that the area is not compared to the frame. The associative memory 126 may control a comparison object in a bit unit.

In the example of the entry search table 126a, the entry of the frame with no tag is registered in the address 100, and the entry (TPID=0x8100, VLAN ID=100) of the frame with one tag is registered in the address 101. In the address 102, the entry (TPID of the tag in the first stage (outside tag)=0x8100, VLAN ID of the tag in the first stage=100, TPID of the tag in the second stage (inside tag)=0x8100, VLAN ID of the tag in the second stage=200) of the two-stage tag frame is registered.

The search by the search key of the associative memory 126 is performed in an order from an address with a smaller number to an address with a larger number. When a corresponding entry is searched, the searching processing ends, and the address value of the associative memory 126 in which the entry is stored is output from the associative memory 126.

For the final address, it is assumed that a final entry with all the masks is set. This makes it possible to determine that the received frame corresponds to the entry of the final address even if the entry corresponding to the received frame is not registered. Accordingly, compared to the search key of the received frame, if the address of the search result transmitted from the associative memory 126 is the final address, the determination indicates that “the received frame corresponds to no entry.”

In the present embodiment, according to the entry flag information of the entry search table 126a, for example, when the frame with the one-stage tag (TPID=0x8100, VLAN ID=100) or the frame with the two-stage tag (TPID of the tag in the first stage=0x8100, VLAN ID of the tag in the first stage=100, TPID of the tag in the second stage=0x8100, VLAN ID of the tag in the second stage=200) is received and the associative memory 126 is searched by the search key of the received frame, the search key of the frame with the one-stage tag or the frame with the two-stage tag does not correspond to the entry of the frame with no tag because the frame with no tag, the frame with the one-stage tag, and the frame with the two-stage tag have different entry flag information in which even the control information is compared in each search. In substantially the same manner, when the frame with the two-stage tag is received and the associative memory 126 is searched by the search key of the received frame, the search key does not correspond to the entry of the frame with the one-stage tag.

According to the present embodiment, in the flag generating processing, the number of VLAN tag stages of the received frame is checked in advance, the frame flag information in accordance to the number of VLAN tag stages is generated. The generated frame flag information is included in the search key. Accordingly, there is no need to consider the order of the addresses of the entry registered in the entry search table 126a of the associative memory 126. This makes it possible to set an arbitrary entry to an arbitrary address of the associative memory 126, so that sorting the entries becomes unnecessary in this case.

As illustrated in the entry search table 126a, the entry of all the masks is set to the final entry. As a result, even if there is a frame that does not correspond to any other entry in the associative memory 126, such frame may be rejected as an unregistered frame because the frame corresponds to the final entry.

FIG. 6 illustrates the entry search table 126a that is stored in the associative memory 126 of the interface card 102a. The entry search table (not illustrated) of the interface cards 102b, 102c, etc., may be realized by the same configuration equivalent to the entry search table 126a.

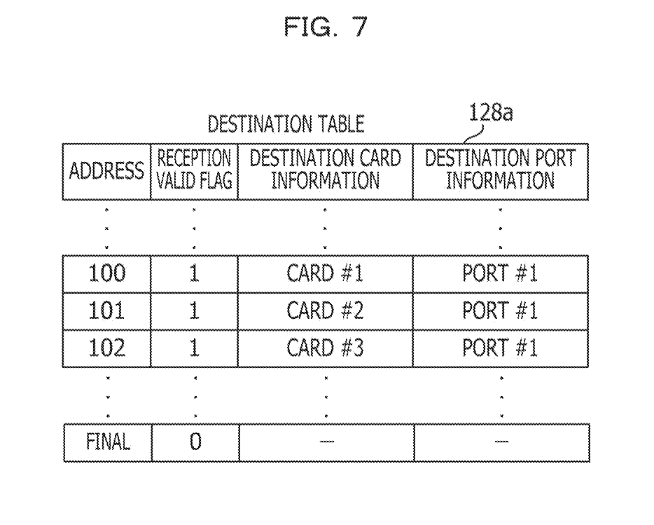

FIG. 7 is a diagram illustrating a data configuration example of a destination table according to the second embodiment. The destination table 128a illustrated in FIG. 7, which is stored in the associate memory 128, stores the destination information indicating a destination of the frame received by the switch 100. The destination table 128a includes an “address,” a “reception valid flag” field, and a “destination card information” field, and a “destination port information” field. The information arranged in the transverse direction of the fields corresponds to each other as the destination information.

The “address” is an address in which the destination information of the associate memory 128 is stored. In the “reception valid flag” field, a flag is set to indicate permission or rejection of reception of the frame received by the interface card 102a having the corresponding search key after comparing the entry search information corresponding to the address to the search key in the entry search table 126a. For the frame corresponding to the entry search information corresponding to the address, if the search key permits the reception of the frame, the value (for example, “1”) indicating validity is set. If the value indicating validity is set in the reception valid flag, the frame is received and is then transferred to a destination indicated by the destination card information and the destination port information. For the frame corresponding to the entry search information corresponding to the address, if the search key rejects the reception of the frame, the value indicating invalidity is set. If the value (for example, “0”) indicating invalidity is set in the reception valid flag, the frame is rejected.

In the “destination card information” field, the information indicating the interface card of the transfer destination of each frame in which the reception is permitted by the reception valid flag is set. In the “destination port information” field, the information indicating the port number in the interface card of the transfer destination of each frame in which the reception is permitted by the reception valid flag is set.

As illustrated in the destination table 128a, the entry of all the masks is set to the final entry. The value “0” is set to indicate invalidity of the reception valid flag of the entry corresponding to all the mask entries. As a result, with respect to an entry corresponding to no entry in the associate memory 128, the frame corresponding to the entry may be rejected as an unregistered frame.

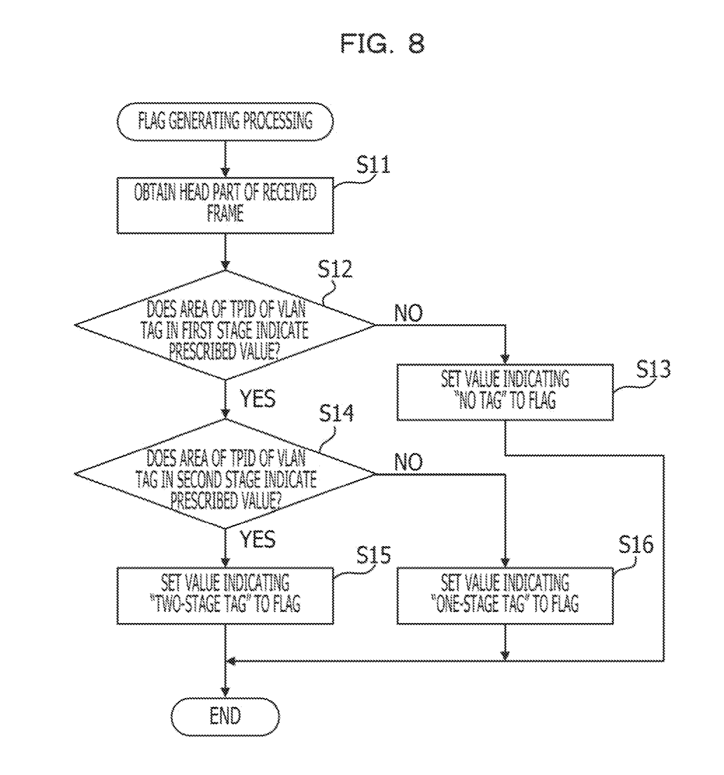

FIG. 8 is a flowchart illustrating a procedure of flag generating processing according to the second embodiment. The flag generating processing illustrated in FIG. 8 is the processing for obtaining the head part of the received frame and generating the frame flag information based on the obtained head part. The flag generating processing is started when the user frame is received by the frame receiving unit 121 and is then transmitted to the flag generating unit 122.

In the flag generating processing according to the present embodiment, as described below, the interface card 102a, which received the user frame, obtains the head part of the received frame. After that, by determining whether or not the VLAN tag is set and determining the number of stages of the VLAN tag after the TPID of the VLAN tag included in the obtained head part is obtained, the frame flag information is set based on the determination result. The flag generated by the flag generating processing is a part of the search key of the received frame and corresponds to the entry flag information of the entry search information.

[Operation S11] The flag generating unit 122 extracts and obtains the head part (for example, 20 bytes from the head) of the received frame.

[Operation S12] The flag generating unit 122 refers to the area (from the head to the 13th byte and the 14th byte) of the TPID of the VLAN tag of the first stage in the head part of the frame obtained in Operation S11, and determines whether or not the area indicates the prescribed value (for example, “0x8100”) indicating the VLAN tag is set in the first stage. If the area of the TPID of the VLAN tag in the first stage indicates the prescribed value, the process goes to Operation S14. On the other hand, if the area of the TPID of the VLAN tag in the first stage does not indicate the prescribed value, the process goes to Operation S13.

[Operation S13] The flag generating unit 122 sets the value (for example, flag with no tag=“1,” one-stage tag flag=“0,” and two-stage tag flag=“0”) indicating “no tag” to the frame flag information of the received frame. After that, the processing ends.

[Operation S14] The flag generating unit 122 refers to the area (from the head to the 17th byte and the 18th byte) of the TPID of the VLAN tag in the second stage in the head part of the frame obtained in Operation S11, and determines whether or not the area indicates the prescribed value indicating that the VLAN tag is set in the second stage. If the area of the TPID of the VLAN tag in the second stage indicates the prescribed value, the process goes to Operation S15. On the other hand, if the area of the TPID of the VLAN tag in the second stage does not indicate the prescribed value, the process goes to Operation S16.

[Operation S15] The flag generating unit 122 sets the value (for example, flag with no tag=“0,” one-stage tag flag=“0,” and two-stage tag flag=“1”) indicating “two-stage tag” to the frame flag information of the received frame. After that, the processing ends.

[Operation S16] The flag generating unit 122 sets the value (for example, “flag with no tag”=“0,” one-stage tag flag=“1,” and two-stage tag flag=“0”) indicating “one-stage tag” to the frame flag information of the received frame. After that, the processing ends.

As described above, according to the second embodiment, the flag generating unit 122 checks the number of tag stages of the VLAN tag in advance and generates the frame flag information according to the number of tag stages. Then the frame flag information is included in the search key. As a result, the corresponding frame and entry may be uniquely specified because the entry to be searched may be specified by comparing the frame flag information to the entry flag information even if there is a mask entry registered in the associative memory 126. Therefore, the order of the addresses of the entries to be registered in the associative memory 126 is not required to be considered. Thus, because the software sets an arbitrary address to an arbitrary entry, sorting the entries is not preferably performed. This makes it possible to reduce the load of the transferring processing of the switch 100 and to achieve stabilization and greater speed for the transferring processing.

By registering all of the mask entries in the final address of the associative memory 126, the frame corresponding to the final entry may be rejected as an unregistered frame. In substantially the same manner, by registering all of the mask entries in the final address of the associate memory 128, the frame corresponding to the final entry may be rejected as an unregistered frame.

### Third Embodiment

A third embodiment will be described. Differences between the above-described second embodiment and the third embodiment will mainly be described. The same parts are indicated with the same numerals, and the same description is omitted.

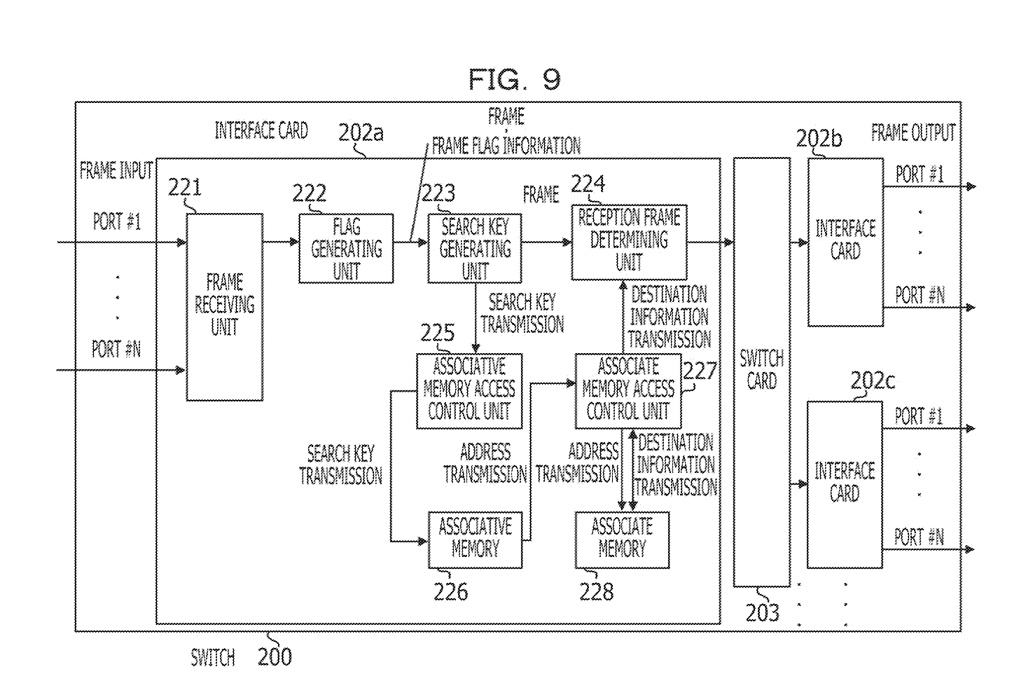

The third embodiment is different from the second embodiment in that there are various types of value of TPID. FIG. 9 is a block diagram illustrating a function of a switch according to the third embodiment. FIG. 9 illustrates an operation of a switch 200 of a case where the frame is received by an interface card 202a and is transferred by the ports #1 to #N of interface cards 202b, 202c, etc., through a switch card 203.

The interface card 202a includes a frame receiving unit 221, a flag generating unit 222, a search key generating unit 223, a reception frame determining unit 224, an associative memory access control unit 225, an associative memory 226, an associate memory access control unit 227, and an associate memory 228.

The interface card 202a includes a line port used to communicate with another coupled communication device or a communication apparatus such as a terminal device, has the interface function with a communication apparatus, and provides reception frame processing, transmission frame processing, and the like.

The frame receiving unit 221 terminates the physical layer and the MAC layer of each reception port of the interface card 202a. The flag generating unit 222 generates the frame flag information as flag information indicating a type of the frame received based on the frame control information of the received frame. The frame flag information indicates the presence and the number of VLAN tags of the received frame.

According to the present embodiment, various types of value of the TPID used for determination of generation of the frame flag information are set in advance. If the value of the area in which the TPID of the received frame corresponds to any of the values set in advance, the flag generating unit 222 determines that the received frame has the VLAN tag and then generates the frame flag information. The flag generating unit 22 checks the number of tag stages of the VLAN tag of the received frame and determines the value of the frame flag information according to the number of tag stages. The generated frame flag information is transmitted with the received frame to the search key generating unit 223.

The search key generating unit 223 generates the search key information that includes all or a part of the frame flag information generated by the flag generating unit 222 and of the frame control information of the received frame.

The search key generating unit 223 obtains the control information from the received frame. Then, the search key generating unit 223 extracts 20 bytes of data from the head to the 20th byte of the received frame to obtain the control information, combines the obtained control information with the frame flag information received by the flag generating unit 222 and the received port number, and transmits the combined information as a search key of the associative memory 226 to the associative memory access control unit 225.

Based on the result of the above-described search, the reception frame determining unit 224 performs the control of the frame received by the frame receiving unit 221 such as determination of a destination, determination of rejection, or the like based on the result of the above-described search. The reception frame determining unit 224 determines a destination of the received frame based on the destination information transmitted from the associate memory access control unit 227. If the reception valid flag of the destination information indicates that the reception of the received frame is rejected, the reception frame determining unit 224 rejects the received frame.

The associative memory access control unit 225 performs the arbitration control of the search with respect to the associative memory 226 transmitted from the search key generating unit 223 and control of the access to the associative memory 226 from the CPU 101.

The associative memory access control unit 225 controls the associative memory 226 and compares the frame flag information of the search key information to the entry flag information of the entry search information. As for the entry search information having the corresponding comparison result, the associative memory access control unit 225 performs the search by comparing the entry control information of the entry search information to the frame control information of the search key information. The associative memory access control unit 225 functions as a search control unit.

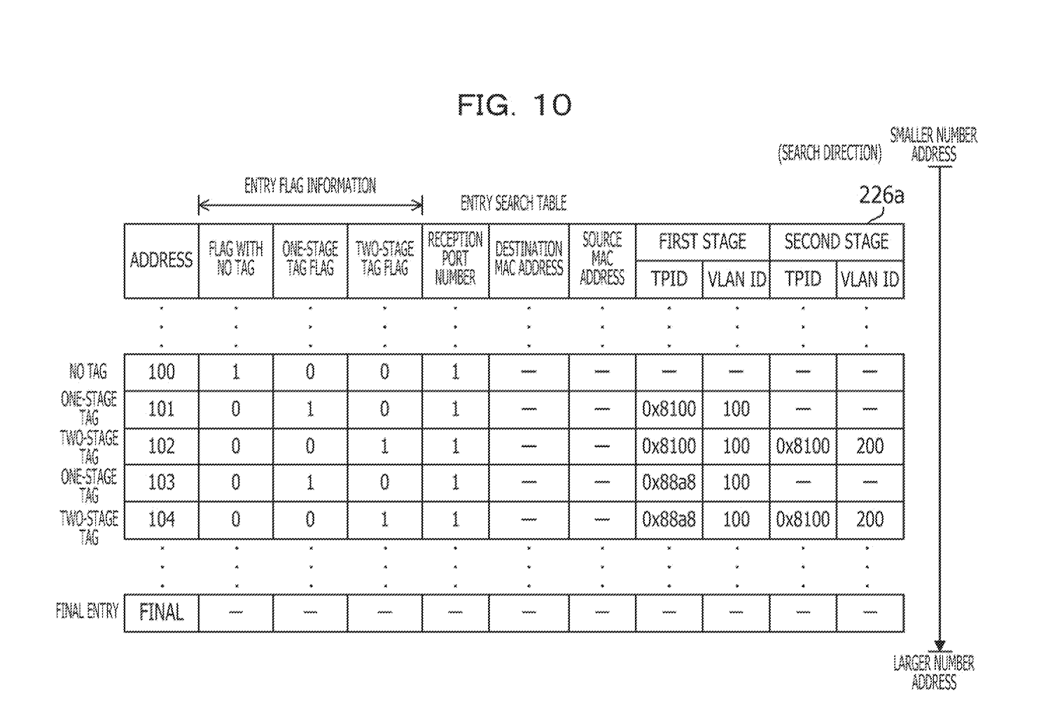

The associative memory 226 stores the entry search information having the entry flag information as flag information indicating a type of the entered frame and having the entry control information as control information of the entered frame. The entry flag information indicates the presence and the number of VLAN tags of the entered frame. The associative memory 226 performs the search by the search key transmitted from the associative memory access control unit 225. If a corresponding entry is searched, the associative memory 226 transmits the address in which the entry is stored to the associate memory access control unit 227. In the present embodiment, as described below in FIG. 10, various types of values of TPID are set in advance in the entry search information. The entry of the associate memory 228 may be read by the transmitted address as an index. The associative memory 226 functions as an entry search information storage unit.

The associate memory access control unit 227 performs the arbitration control of the access from the associative memory 226 and of the access to the associate memory 228 from the CPU 101. According to the entry search information that is searched from the associative memory 226 by a sequence of the searching processing, the associate memory access control unit 227 transmits, to the reception frame determining unit 224, the destination information of the received frame stored in the associate memory 228. The associate memory access control unit 227 functions as a destination control unit.

The associate memory 228 stores the destination information indicating the destination of the received frame. The destination information includes the reception valid flag indicating whether the reception of the received frame is permitted or rejected. The associate memory 228 functions as a destination information storage unit.

The interface cards 202b, 202c, etc., are configured similarly to the interface card 202a and have substantially the same function equivalent to the interface card 202a. Based on the determination result of the reception frame determining unit 224, the switch card 203 transfers the user frame from the interface card by which the user frame was received to the interface card by which the user frame is to be transmitted. Based on this, the frame is output from the port of the interface card by which the user frame was transferred.

FIG. 10 is a diagram illustrating a data configuration example of an entry search table according to the third embodiment. The entry search table 226a illustrated in FIG. 10 illustrates the configuration of the entry of the frame received by the switch 200, which is stored in the associative memory 226. The entry search table 226a stores the entry search information indicating the search condition of each entry compared to the search key of the frame received by the switch 200. As with the entry search table 126a according to the second embodiment, the entry search table 226a includes an “address,” a “flag with no tag” field, a “one-stage tag flag” field, a “two-stage tag flag” field, a “reception port number” field, a “source MAC address” field, a “source MAC address” field, a “TPID ID” filed (the first stage), a “TPID” field (the second stage), and a “VLAN ID” field (the second stage). The information arranged in the transverse direction of the fields corresponds to each other as the entry search information.

In IEEE802.1q, in the configuration in which a plurality of VLAN tags is stacked, there are two types of tag: a customer tag (C tag) used in a user network, and a service tag (S tag) used in a carrier network as a communication provider. IEEE802.1q specifies that the TPID of the C tag indicates 0x8100, and the TPID of the S tag indicates 0x88a8. According to the present embodiment, a VLAN tag frame supports a plurality of tag stages. The VLAN tag frame may be used when two different TPIDs are used in the tag of the first stage and in the tag of the second stage, respectively.

As with the second embodiment, in the example of the entry search table 226a, the entry of the frame with no tag is registered in the address 100, and the entry (TPID=0x8200, VLAN ID=100) of the frame with the one-stage tag is registered in the address 101. The entry (TPID of the tag in the first stage=0x8100, VLAN ID=100, TPID of the tag in the second stage=0x8100, VLAN ID=200) of the frame with the two-stage tag is registered in the address 102

In the example of the entry search table 226a, the entry (TPID=0x88a8, VLAN ID=100) of the frame with the one-stage tag is registered in the address 103. The entry (TPID of the tag in the first stage=0x88a8, VLAN ID of the tag in the firs stage=100, TPID of the tag in the second stage=0x8100, VLAN ID of the tag in the second stage=200) of the frame with the two-stage tag is registered in the address 104.

FIG. 10 illustrates the entry search table 226a stored in the associative memory 226 of the interface card 202a. The entry search table (not illustrated) of another interface card in the switch 200 of the interface cards 202b, 202c, etc., may be realized by substantially the same configuration equivalent to the entry search table 226a.

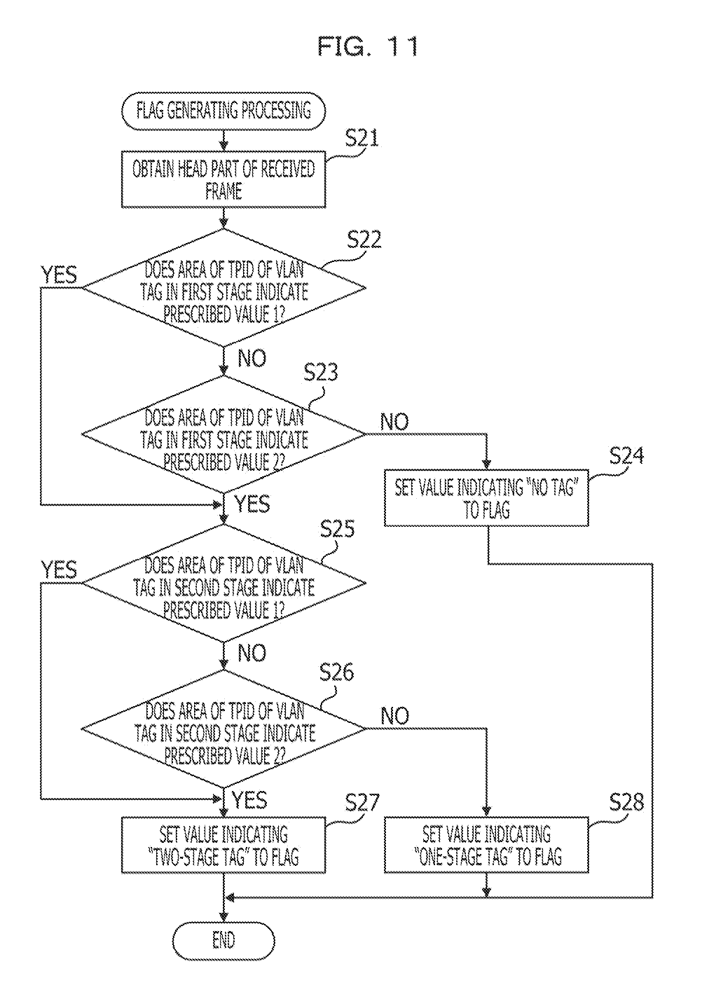

FIG. 11 is a flowchart illustrating a procedure of flag generating processing according to the third embodiment. The flag generating processing illustrated in FIG. 11 is processing for obtaining the head part of the received frame and generating the frame flag information based on the obtained head part. The flag generating processing is started when the user frame is received by the frame receiving unit 221 and is then transmitted to the flag generating unit 222.

As described below, in the flag generating processing according to the present embodiment, the head part of the received frame is obtained by the interface card 202a that received the user frame. After that, if the TPID of the VLAN tag indicates two types, that is, “0x8100” and “0x88a8”, for example, by determining whether or not the VLAN tag of any of the TPIDs is set and determining the number of stages of the VLAN tag after the TPID of the VLNA tag included in the obtained head part is obtained, the frame flag information is set based on the determination result. The flag generated by the flag generating processing is a part of the search key of the received frame and corresponds to the entry flag information of the entry search information.

[Operation S21] The flag generating unit 222 extracts and obtains the head part (for example, 20 bytes from the head) of the received frame.

[Operation S22] The flag generating unit 222 refers to the area (from the head to the 13th byte and the 14th byte) of the TPID of the VLAN tag in the first stage of the head part of the frame obtained in Operation S21, and then determines whether or not the area indicates a prescribed value 1 (for example, “0x8100”) indicating that the VLAN tag is set in the first stage. If the area of the TPID of the VLAN tag in the first stage indicates the prescribed value 1, the process goes to Operation S25. On the other hand, if the area of the TPID of the VLAN tag in the first stage does not indicate the prescribed value 1, the process goes to Operation S23.

[Operation S23] The flag generating unit 222 refers to the area of the TPID of the VLAN tag in the first stage in the head part of the frame obtained in Operation S21, and then determines whether or not the area indicates a prescribed value 2 (for example, “0x88a8”) indicating that the VLAN tag is set in the first stage. If the area of the TPID of the VLAN tag in the first stage indicates the prescribed value 2, the process goes to Operation S25. On the other hand, if the area of the TPID of the VLAN tag in the first stage does not indicate the prescribed value 2, the process goes to Operation S24.

[Operation S24] The flag generating unit 222 sets the value (for example, flag with no tag=“1,” one-stage tag flag=“0,” and two-stage tag flag=“0”) indicating “no tag” to the frame flag information of the received frame. After that, the processing ends.

[Operation S25] The flag generating unit 222 refers to the area (from the head to the 17th byte and the 18th byte) of the TPID of the VLAN tag in the second stage in the head part of the frame obtained in Operation S21, and then determines whether or not the area indicates the prescribed value 1 indicating that the VLAN tag is set in the second stage. If the area of the TPID of the VLAN tag in the second stage indicates the prescribed value 1, the process goes to Operation S27. On the other hand, if the area of the TPID of the VLAN tag in the second stage does not indicate the prescribed value 1, the process goes to Operation S26.

[Operation S26] The flag generating unit 222 refers to the area of the TPID of the VLAN tag in the second stage of the head part of the frame obtained in Operation S21, and then determines whether or not the area indicates the prescribed value 2 indicating that the VLAN tag is set in the second stage. If the area of the TPID of the VLAN tag in the second stage indicates the prescribed value 2, the process goes to Operation S27. On the other hand, if the area of the TPID of the VLAN tag in the second stage does not indicate the prescribed value 2, the process goes to Operation S28.

[Operation S27] The flag generating unit 222 sets the value (for example, flag with no tag=“0,” one-stage tag flag=“0,” and two-stage tag flag=“1”) indicating “two-stage tag” to the frame flag information of the received frame. After that, the processing ends.

[Operation S28] The flag generating unit 222 sets the value (for example, flag with no tag=“0,” one-stage tag flag=“1,” and two-stage tag flag=“0”) indicating “one-stage tag” to the frame flag information of the received frame. After that, the processing ends.

As described above, in addition to the second embodiment, the third embodiment is applicable to a case where there is a VLAN tag that has various types of TPID.

### Fourth Embodiment

A fourth embodiment will be described. A difference between the above-described second embodiment and the fourth embodiment will be mainly described. The same parts are indicated with the same numerals, and the same description is omitted.

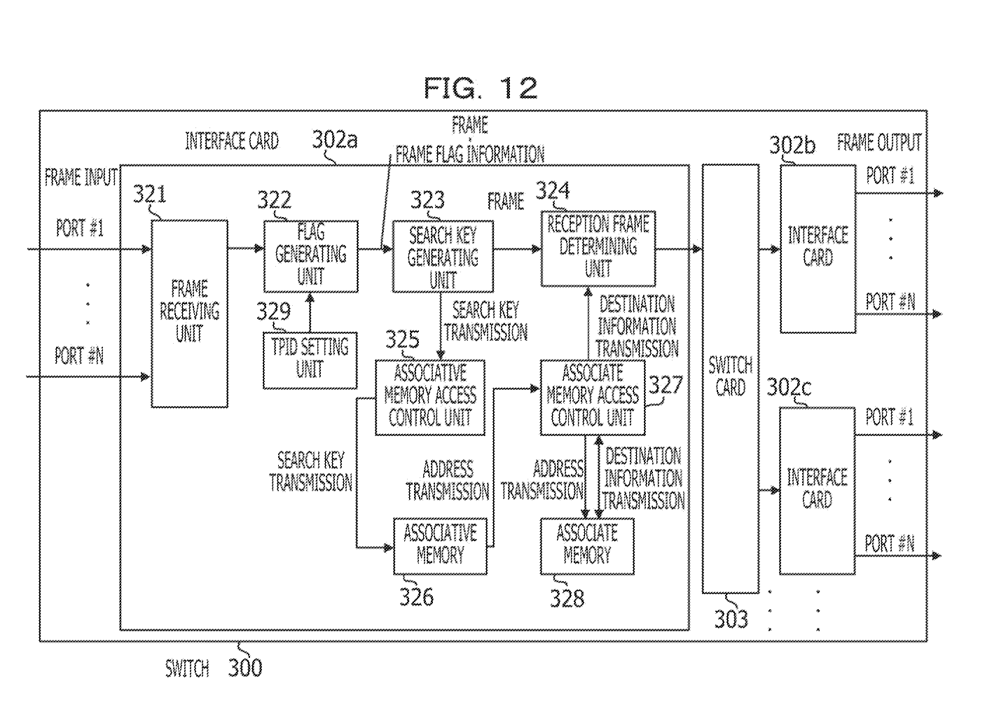

The fourth embodiment is different from the second embodiment in that an arbitrary TPID value may be set. FIG. 12 is a block diagram illustrating a function of a switch according to the fourth embodiment. FIG. 12 illustrates an operation of the switch 300 of a case where the frame is received by an interface cards 302a and is transferred by the ports #1 to #N of the interface cards 302b, 302c, etc., through a switch card 303.

The interface card 302a includes a frame receiving unit 321, a flag generating unit 322, a search key generating unit 323, a reception frame determining unit 324, an associative memory access control unit 325, an associative memory 326, an associate memory access control unit 327, an associate memory 328, and a TPID setting unit 329.

The interface card 302a includes a line port used to communicate with another coupled communication device or a communication apparatus such as a terminal device, has the interface function with a communication apparatus, and provides reception frame processing, transmission frame processing, and the like.

The frame receiving unit 321 terminates the physical layer and the MAC layer of each reception port of the interface card 302a. The flag generating unit 322 generates the frame flag information as flag information indicating a type of the frame received based on the frame control information of the received frame. The frame flag information indicates the presence and the number of VLAN tags of the received frame.

According to the present embodiment, various types of value of TPID used for determination of generation of the frame flag information are set in advance. If the value of the area in which the TPID of the received frame is set corresponds to any of the values set in advance, the flag generating unit 322 determines that the received frame has the VLAN tag and generates the frame flag information. The flag generating unit 322 checks the number of tag stages of the VLAN tag of the received frame and determines the value of the frame flag information according to the number of tag stages. The generated frame flag information is transmitted with the received frame to the search key generating unit 323.

The search key generating unit 323 generates the search key information that includes all or part of the frame flag information generated by the flag generating unit 322 and of the frame control information of the received frame.

The search key generating unit 323 obtains the control information from the received frame. Then, the search key generating unit 323 extracts 20 bytes of data from the head to the 20th byte of the received frame to obtain the control information, combines the obtained control information with the frame flag information received from the flag generating unit 322 and the received port number, and transmits the combined information as a search key of the associative memory 326 to the associative memory access control unit 325.

As for the frame received by the frame receiving unit 321, the reception frame determining unit 324 performs the control of the received frame such as determination of a destination, determination of rejection, or the like based on a result of the above-described search. The reception frame determining unit 324 determines a destination of the received frame based on the destination information transmitted from the associate memory access control unit 327. If the reception valid flag of the destination information indicates that the reception of the received frame is rejected, the reception frame determining unit 324 rejects the received frame.

The associative memory access control unit 325 performs the arbitration control of the search with respect to the associative memory 326 transmitted from the search key generating unit 323 and of the access to the associative memory 326 from the CPU 101.

The associative memory access control unit 325 controls the associative memory 326 and compares the frame flag information of the search key information to the entry flag information of the entry search information. As for the entry search information having the corresponding comparison result, the associative memory access control unit 325 performs the search by comparing the entry control information of the entry search information to the frame control information of the search key information. The associative memory access control unit 325 functions as a search control unit.

The associative memory 326 stores the entry search information having the entry flag information as flag information indicating a type of the entered frame and having the entry control information as control information of the entered frame. The entry flag information indicates the presence and the number of VLAN tags of the entered frame. The associative memory 326 performs the search by the search key transmitted from the associative memory access control unit 325. If a corresponding entry is searched, the address in which the entry is stored is transmitted to the associate memory access control unit 327. In the present embodiment, various types of value of TPID are set in advance as for the entry search information. The entry of the associate memory 328 may be read by the transmitted address as an index. The associative memory 326 functions as an entry search information storage unit.

The associate memory access control unit 327 performs the arbitration control of the access from the associative memory 326 and of the access to the associate memory 328 from the CPU 101. According to the entry search information that is searched from the associative memory 326 by a sequence of the searching processing, the associate memory access control unit 327 transmits to the reception frame determining unit 324 the destination information of the received frame stored in the associate memory 328. The associate memory access control unit 327 functions as a destination control unit.

The associate memory 328 stores the destination information indicating the destination of the received frame. The destination information includes the reception valid flag indicating whether the reception of the received frame is permitted or rejected. The associate memory 328 functions as a destination information storage unit.

The TPID setting unit 329 receives an input of a value of TPID from a management terminal device (not illustrated), sets TPID setting information indicating the received value of the TPID, and stores the set TPID setting information. The TPID setting unit 329 transmits the TPID setting information according to a request from the flag generating unit 322.

The interface cards 302b, 302c, etc., are configured similarly to the interface card 302a and have the same function equivalent to the interface card 302a. Based on the determination result of the reception frame determining unit 324, the switch card 303 transfers the user frame from the interface card by which the user frame was received to the interface card by which the user frame is to be transmitted. Based on this, the frame is output from the port of the interface card by which the frame was transferred.

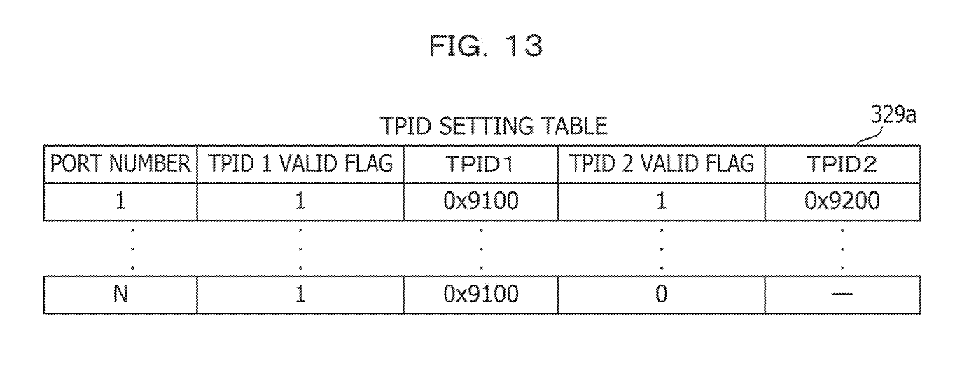

FIG. 13 is a diagram illustrating a data configuration example of a TPID setting table according to the fourth embodiment. The TPID setting table 329a illustrated in FIG. 13 stores the TPID setting information indicating whether the VLAN tag of the frame received by the switch 300 indicates validity or invalidity. The TPID setting table 329a is managed by the TPID setting unit 329 and stored. In the TPID setting table 329a, the value of TPID 1 as TPID used in the VLAN tag in the first stage for each port of the interface card 302a and the value of TPID 2 as TPID used in the VLAN tag in the second stage are settable.

The TPID setting table 329a includes a “port number” field, a “TPID 1 valid flag” field, a “TPID 1” field, a “TPID 2 valid flag” field, and a “TPID 2” field. The information arranged in the transverse direction of the fields corresponds to each other as the TPID setting information.

In the “port number” field, the port number by which the frame is received is set. Each of the TPID setting information is used for determination of the TPID of the frame received by the port indicated in the port number field.

In the “TPID 1 valid flag” field, the flag indicating whether the TPID set to the TPID 1 is valid or invalid is set. If the TPID is valid, the value (for example, “1”) indicating validity is set. If the value indicating validity is set to the TPID 1 valid flag, the TPID indicated by the TPID 1 is used to determine the presence of the VLAN tag in the first stage in flag generation of the frame received by the interface card 302a. If the value (for example, “0”) indicating invalidity is set to the TPID valid flag, the TPID indicated by the TPID 1 is not used in the flag generation of the frame received by the interface card 302a, and the determination indicates absence of the VLAN tag in the first stage.

In the “TPID 1” field, the value of TPID, which is used to determine whether the received frame has the VLAN tag in the first stage if the value of the TPID 1 valid flag indicates validity, is set.

In the “TPID 2 valid flag” field, the flag indicating whether the TPID set to TPID 2 is valid or invalid is set. If the TPID is valid, the value indicating validity is set. If the value indicating validity is set to the TPID 2 valid flag, the TPID indicated by the TPID 2 is used to determine the presence of the VLAN tag in the second stage in the flag generation of the frame received by the interface card 302a. If the value indication invalidity is set to the TPID valid flag, the TPID indicated by the TPID 2 is not used in the flag generation of the frame received by the interface card 302a, and the determination indicates the absence of the VLAN tag in the second stage.

In the “TPID 2” field, the value of the TPID used to determine whether or not the received frame has the VLAN tag in the second stage if the value of the TPID 2 valid flag indicates validity.

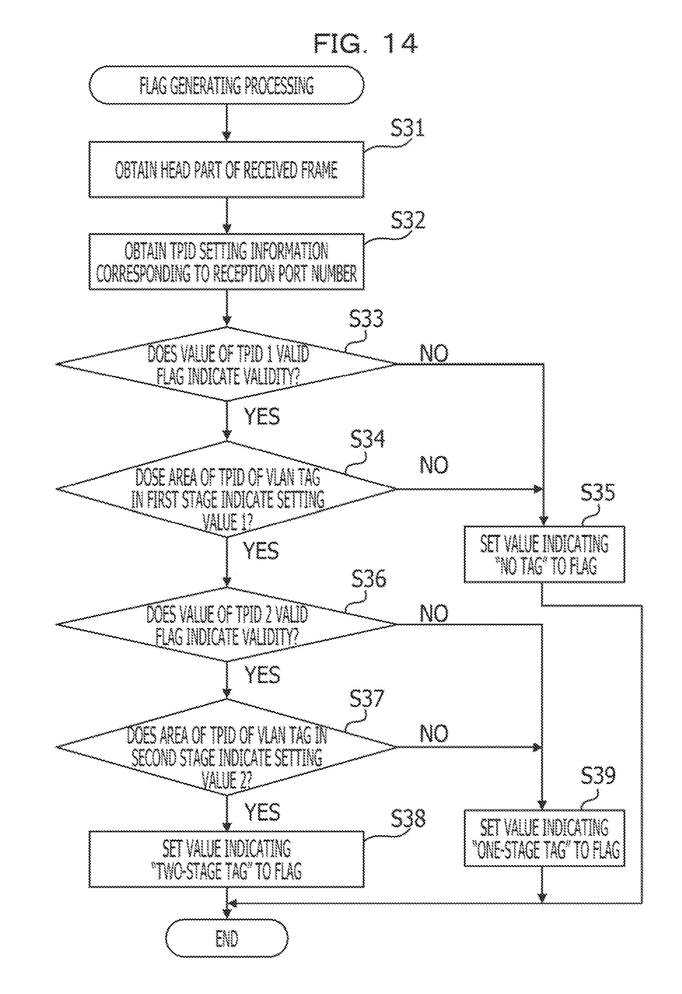

According to the present embodiment, the TPDI setting table 329a makes it possible to expressly set the TPID value of the VLAN tag in each stage for each port. FIG. 14 is a flowchart illustrating a procedure of flag generating processing according to a fourth embodiment. The flag generating processing illustrated in FIG. 14 is processing for obtaining the head part of the received frame and generating the frame flag information based on the obtained head part. The flag generating processing is started when the user frame is received by the frame receiving unit 321 and is then transmitted to the flag generating unit 322.

As described below, in the flag generating processing according to the present embodiment, as described below, the interface card 302a, which received the users frame, obtains the head part of the received frame. After that, by determining whether or not the VLAN tag is set and determining the number of stages of the VLAN tag after the TPID of the VLAN tag included in the obtained head part is obtained, the frame flag information is set based on the determination result. The flag generated by the flag generating processing is a part of the search key of the received frame and corresponds to the entry flag information of the entry search information.

[Operation S31] The flag generating unit 322 extracts and obtains the head part (for example, 20 bytes from the head) of the received frame.

[Operation S32] The flag generating unit 322 obtains the TPID setting information according to the port number by which the frame is received from the TPID setting unit 329.

[Operation S33] With reference to the TPID setting information obtained in Operation S32, the flag generating unit 322 determines whether the value of the TPID 1 valid flag is “1” indicating validity or “0” indicating invalidity. If the value of the TPID 1 valid flag indicates validity, the process goes to Operation S34. On the other hand, if the value of the TPID 1 valid flag indicates invalidity, the process goes to Operation S35.

[Operation S33] With reference to the area (from the head to the 13th byte and the 14th byte) of the TPID of the VLAN tag in the first stage of the head part of the frame obtained in Operation S31, the flag generating unit 322 determines whether or not the area indicates a setting value 1 (for example, “0x9100”) that is set to the TPID 1 of the TPID setting information obtained in Operation S32. If the area of the TPID of the VLAN tag in the first stage indicates the setting value 1, the process goes to Operation S36. On the other hand, if the area of the TPDI of the VLAN tag in the first stage does not indicate the setting value 1, the process goes to Operation S35.

[Operation S35] The flag generating unit 322 sets the value (for example, flag with no tag=“1,” one-stage tag flag=“0,” and two-stage tag flag=“0”) indicating “no tag” to the frame flag information of the received frame. After that, the processing ends.

[Operation S36] With reference to the TPID setting information obtained in Operation S32, the flag generating unit 322 determines whether the value of the TPID 2 valid flag is “1” indicating validity or “0” indicating invalidity. If the value of the TPID 2 valid flag indicates validity, the process goes to Operation S37. On the other hand, if the value of the TPID 2 valid flag indicates invalidity, the process goes to Operation S39.

[Operation S37] With reference to the area of the TPID of the VLAN tag in the second stage of the head part of the frame obtained in Operation S31, the flag generating unit 322 determines whether the area (from the head to the 17th byte and the 18th byte) indicates a setting value 2 (for example, “0x9200”) that is set to the TPID 2 of the TPID setting information obtained in Operation S32. If the area of the TPID of the VLAN tag in the second stage indicates the setting value 2, the process goes to Operation S38. On the other hand, if the area of the TPID of the VLAN tag in the second stage does not indicate the setting value 2, the process goes to Operation S39.

[Operation S38] The flag generating unit 322 sets the value (for example, flag with no tag=“0,” one-stage tag flag=“0,” and two-stage tag flag=“1”) indicating “two-stage tag” to the frame flag information of the received frame. After that, the processing ends.

[Operation S39] The flag generating unit 322 sets the value (for example, flag with no tag=“0,” one-stage tag flag=“1,” and two-stage tag flag=“0”) indicating “one-stage tag” to the frame flag information of the received frame. After that, the processing ends.

As described above, according to IEEE standard specifications, the TPDI of the C tag is specified to be 0x8100, and the TPID of the S tag is specified to be 0x88a8. However, when being used in a private network or used by a communication carrier for example, it may be desired to be able to set an arbitrary TPID value. In the present embodiment, an arbitrary TPID value may be set with respect to the VLAN tag in the first stage and the VLAN tag in the second stage for each port, respectively.

As described above, according to the fourth embodiment in addition to the second embodiment, determination by the arbitrary TPID value for each port may be performed with respect to an Ethernet frame with a plurality of VLAN tags. Accordingly, a more flexible VLAN network may be structured.

### Fifth Embodiment

A fifth embodiment will be described. The differences between the second embodiment and the fifth embodiment will mainly be described. The same parts are indicated with the same numerals, and the same description is omitted.

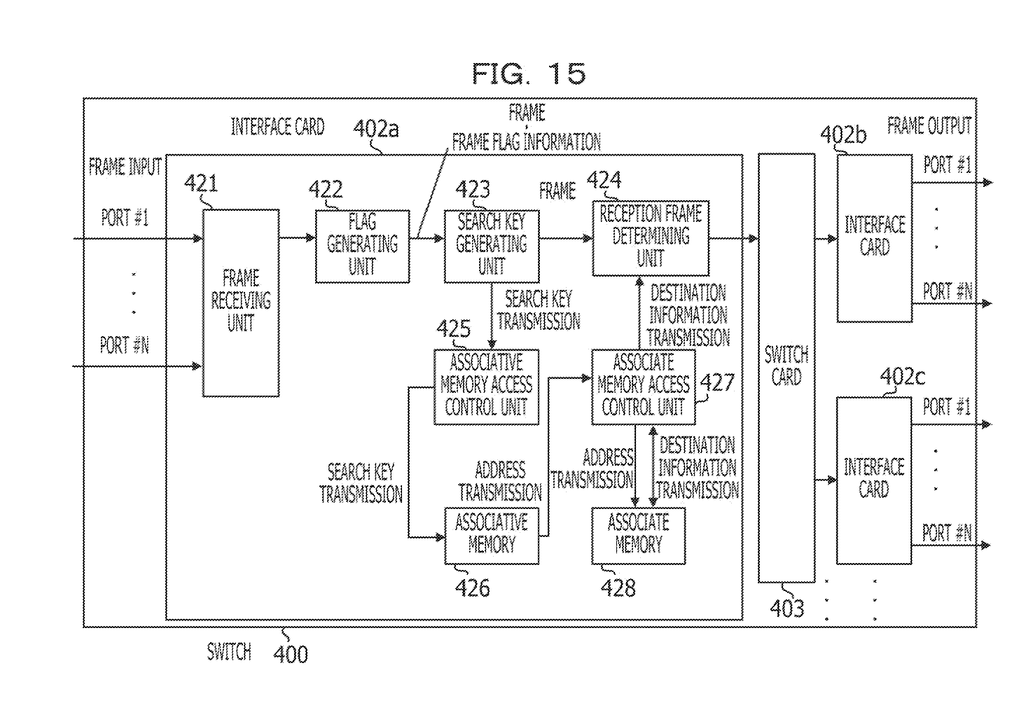

The fifth embodiment is different from the second embodiment in that determination of the upper layer in which the Ethernet frame is transferred may be performed. FIG. 15 is a block diagram illustrating a function of a switch according to the fifth embodiment. FIG. 15 illustrates an operation of a switch 400 of a case where the frame is received by an interface card 402a and is transferred by the ports #1 to #N of interface cards 402b, 402c, etc., through a switch card 403.

The interface card 402a includes a frame receiving unit 421, a flag generating unit 422, a search key generating unit 423, a reception frame determining unit 424, an associative memory access control unit 425, an associative memory 426, an associate memory access control unit 427, and an associate memory 428.

The interface card 402a includes a line port used to communicate with another coupled communication device or communication apparatus such as a terminal device, has the interface function with a communication apparatus, and provides the reception frame processing, the transmission frame processing, and the like.

The frame receiving unit 421 terminates the physical layer and the MAC layer of each reception port of the interface card 402a. The flag generating unit 422 generates the frame flag information as flag information indicating a type of the frame received based on the frame control information of the received frame. The frame flag information indicates the presence and the number of VLAN tags of the received frame.

According to the present embodiment, various types of value of the TPID used for determination of generation of the frame flag information are set in advance. If the value of the area in which the TPID of the received frame is set corresponds to any of the values set in advance, the flag generating unit 422 determines that the received frame has the VLAN tag and generates the frame flag information. The flag generating unit 422 checks the number of tag stages of the VLAN tag of the received frame and determines the value of the frame flag information according to the number of tag stages. The generated frame flag information is transmitted with the received frame to the search key generating unit 423.

The search key generating unit 423 generates the search key information that includes all or part of the frame flag information generated by the flag generating unit 422 and the frame control information of the received frame.

The search key generating unit 423 obtains the control information from the received frame. Then, according to the present embodiment the search key generating unit 423 extracts 22 bytes of data from the head to the 22nd byte of the received frame to obtain the control information, combines the obtained control information with the frame flag information received from the flag generating unit 422 and the port number, and transmits the combined information as a search key of the associative memory 426 to the associative memory access control unit 425.

As described above, according to the present embodiment, the frame control information includes the E-TYPE as the data of the area positioned right after the VLAN tag in the second stage as frame upper protocol information indicating a protocol of the upper layer of the received frame. As a result, the E-TYPE may be searched if the search is performed in the associative memory 426 even when the VLAN with the two-stage tag is received.

For the frame received by the frame receiving unit 421, the reception frame determining unit 424 performs the control of the received frame such as determination of a destination, determination of rejection, or the like based on a result of the above-described search. The reception frame determining unit 424 determines the destination of the received frame based on the destination information transmitted from the associate memory access control unit 427. If the reception valid flag of the destination information indicates that the reception of the received frame is rejected, the reception frame determining unit 424 rejects the received frame.

The associative memory access control unit 425 performs the arbitration control of the search with respect to the associative memory 426 transmitted from the search key generating unit 423 and of the access to the associative memory 426 from the CPU 101.

The associative memory access control unit 425 controls the associative memory 426, and compares the frame flag information of the search key information to the entry flag information of the entry search information. For the entry search information having the corresponding comparison result, the associative memory access control unit 425 performs the search by comparing the entry control information of the entry search information to the frame control information of the search key information. The associative memory access control unit 425 functions as a search control unit.

The associative memory 426 stores the entry flag information as flag information indicating a type of the entered frame and the entry search information of the entry control information as control information of the entered frame. The entry flag information indicates the presence and the number of VLAN tags of the entered frame. The associative memory 426 performs the search by the search key transmitted from the associative memory access control unit 425. If a corresponding entry is searched, the address in which the entry is stored is transmitted to the associate memory access control unit 427.

According to the present embodiment, the entry control information is provided with an area of the E-TYPE as entry upper protocol information indicating a protocol of the upper layer of the entered frame. This makes it possible to search the entry where the E-TYPE is included in the search condition with respect to the received frame. The entry of the associate memory 428 may be read by the address as an index. The associative memory 426 functions as an entry search information storage unit.

The associate memory access control unit 427 performs the arbitration control of the access from the associative memory 426 and of the access to the associate memory 428 from the CPU 101. According to the entry search information searched from the associative memory 426 by a sequence of the search processing, the associate memory access control unit 427 transmits, to the reception frame determining unit 424, the destination information of the received frame stored in the associate memory 428. The associate memory access control unit 427 functions as a destination control unit.

The associate memory 428 stores the destination information indicating the destination of the received frame. The destination information includes the reception valid flag indicating whether the reception of the received frame is permitted or rejected. The associate memory 428 functions as a destination information storage unit.

The interface cards 402b, 402c, etc., are configured similarly to the interface card 402a and have substantially the same function equivalent to the interface card 402a. Based on the determination result of the reception frame determining unit 424, the switch card 403 transfers the user frame from the interface card by which the user frame was received to the interface card by which the user frame is to be transmitted. Based on this, the frame is output from the port of the interface card by which the frame is transferred.

The associative memory access control unit 425 may perform the search by comparing the R-TYPE of the control information of the received frame to the E-TYPE of the entry flag control information.

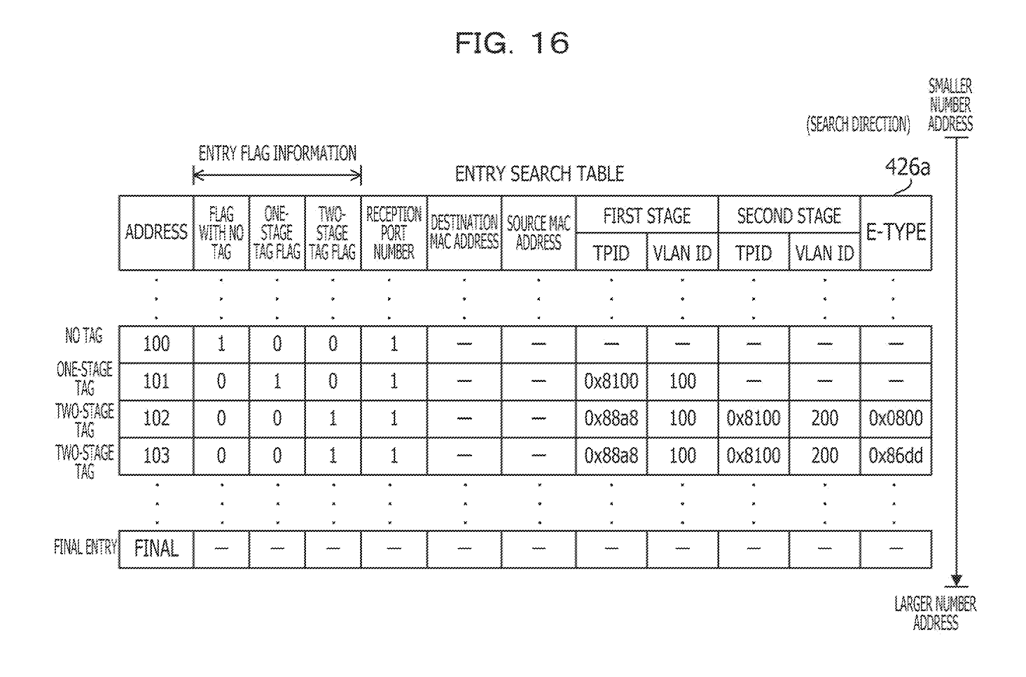

FIG. 16 is a diagram illustrating a data configuration example of an entry search table according to the fifth embodiment. The entry search table 426a illustrated in FIG. 16 illustrates a configuration of the entry of the frame received by the switch 400, which is stored in the associative memory 426. The entry search table 426a stores the entry search information indicating a search condition of each entry compared to the search key of the frame received by the switch 400. The entry search table 426a has an “address,” a “flag with no tag” field, a “one-stage tag flag” field, a “two-stage tag flag” field, a “reception port number” field, a “destination MAC address” field, a “source MAC address” field, a “TPID” field (the first stage), a “VLAN ID” field (the second stage), a “TPID” field (the second stage), a “VLAN ID” field (the second stage), and an “E-TYPE” field. The information arranged in the transverse direction of the fields corresponds to each other as the entry search information.

The “E-TYPE” field is a 2-byte area indicating the E-TYPE as an identifier of the upper layer as the search condition of the entry. In the E-TYPE field, “0x0800” indicates an IPv4 frame. Moreover, “0x86dd” indicates an IPv6 frame.

In the example of the entry search table 426a, the entry of the frame with no tag is registered in the address 100, and the entry (TPID=0x8100, VLAN ID=100) of the one-stage tag frame is registered in the address 101. The entry (TPID of the tag in the first stage=0x88a8, VLAN ID of the tag in the first tag=100, TPID of the tag in the second stage=0x8100, VLAN ID=200 of the tag in the second stage=200, E-TYPE=0x0800) is registered in the address 102. The entry (TPID of the tag the first stage=0x88a8, VLAN ID of the tag in the first stage=100, TPID of the tag in the second stage=0x8100, VLAN ID of the tag in the second stage=200, E-TYPE=0x86dd) of the frame with the two-stage tag is registered in the address 103.

According to the present embodiment, if the upper layer indicates the IPv4 frame and the IPv6 frame, the E-TYPE field makes it possible to set different entries to the TPID of the tag in the first stage=0x88a8 and VLAN ID=100 as described in the entries of the addresses 102 and 103 of the entry search table 426a. As a result, the determination of the frame may be performed up to the upper layer.

As illustrated in the entry search table 426a, the entry with all the masks is set to a final entry. As a result, even if there is a frame that does not correspond to any other entry in the associative memory 426, such frame may be rejected as an unregistered frame because the frame corresponds to the final entry.

FIG. 16 illustrates an entry search table 426a stored in the associative memory 426 of the interface card 402a. The entry search table (not illustrated) of another interface card in the switch 400 of the interface cards 402b, 402c, etc., may be realized by substantially the same configuration equivalent to the entry search table 426a.

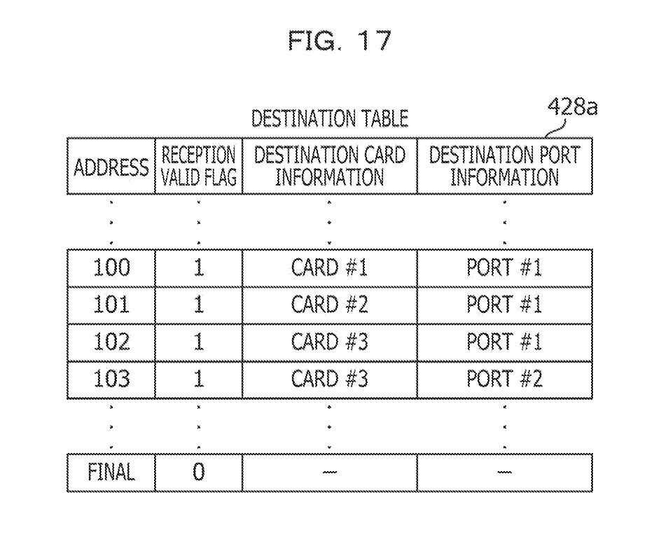

FIG. 17 is a diagram illustrating a data configuration example of a destination table according to a fifth embodiment. The destination table 428a illustrated in FIG. 17 stores the destination information indicating a destination of the frame received by the switch 400, which is stored in the associate memory 428. As with the destination table 128a according to the second embodiment, the destination table 428a has an “address,” a “reception valid flag,” field, a “destination card information” field, and a “destination port information” field. The information arranged in the transverse direction of the fields corresponds to each other as the destination information.

For the entry of the associate memory 428 illustrated in the destination table 428a, the “port #1” of the “card #3” (for example, the card #3 indicates the interface card 402c) is set as the destination in the address 102 corresponding to the entry of the IPv4 frame. In the address 103 corresponding to the entry of the IPv6 frame, the “port #2” of the “card #3” is set as the destination. Accordingly, in the present embodiment, transfer to different destinations in a frame type unit of the upper layer may be performed.

As described in the destination table 428a, the entry of all the mask is set to the final entry. The value “0” indicating invalidity is set to the reception valid flag of the entry corresponding to all the mask entries. As a result, even if there is a frame that does not correspond to any other entry in the associate memory 428, such frame may be rejected as an unregistered frame because the frame corresponds to the final entry.

According to the fifth embodiment in addition to the second embodiment, determination of a frame type of different upper layers may be performed. By using the determination result of the different upper layers, transfer to a different destination according to the upper layer of the frame may be performed.

Although the description was made of the disclosed communication device based on the illustrated embodiments, the description simply illustrates only the basis of the present invention. The disclosed techniques are not limited to the precise configuration and the application examples described above. The configuration of each unit may be replaced by an arbitrary configuration with the same function. The disclosed techniques may be added with other arbitrary components or procedures. Furthermore, the disclosed techniques may be a combination of two or more configurations from among the above-described embodiments. All of the modifications and equivalents corresponding to the disclosed techniques are considered to be in the range of the present invention with the attached claims and the equivalents thereof.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Although the embodiment(s) of the present invention(s) has (have) been described in detail, it should be understood that the various changes, substitutions, and alterations could be made hereto without departing from the spirit and scope of the invention.

What is claimed is:

1. A communication device comprising:
an entry search information storage unit to store entry flag information indicating a type of an entered frame and entry search information having entry control information as control information of the entered frame,
a flag generating unit to generate frame flag information indicating a type of a frame received by the communication device based on frame control information of the received frame,
a search key generating unit to generate search key information having all or part of the frame flag information and of the frame control information of the received frame, and
a search control unit to control the entry search information storage unit, compare the frame flag information of the search key information to the entry flag information of the entry search information, and search the entry search information having a corresponding comparison result by the frame control information of the search key information.

2. The communication device according to claim 1, wherein the communication device is one of a L2 switch and a L3 switch that provide a Virtual Local Area Network (VLAN) routing.

3. The communication device according to claim 1, wherein the frame flag information indicates a presence of a Virtual Local Area Network (VLAN) tag of the received frame, and the entry flag information indicates a presence of the VLAN tag of the entered frame.

4. The communication device according to claim 3, wherein the flag generating unit generates the frame flag information after determining that the received frame has the VLAN tag when a value of an area in which a Tag Protocol Identifier (TPID) of the received frame is set corresponding to a prescribed value.

5. The communication device according to claim 4, wherein various types of values of the TPID are set in advance, and
wherein the flag generating unit generates the frame flag information after determining that the received frame has the VLAN tag when the value of the area in which the TPID of the received frame is set to any of the values which are set in advance.

6. The communication device according to claim 4, further comprising a TPID setting unit which receives a value of the TPID, sets TPID setting information indicating the received value of the TPID, and stores the TPID setting information.

7. The communication device according to claim 3, wherein the frame flag information indicates a presence and a number of the VLAN tags of the received frame, and wherein the entry flag information indicates the presence and the number of the VLAN tags of the entered frame.

8. The communication device according to claim 1, wherein the entry search information storage unit includes an associative memory which stores the entry search information, and wherein the search control unit searches the entry search information by transmitting the search key information to the associative memory.

9. The communication device according to claim 1, wherein the frame control information includes frame upper protocol information indicating a protocol of an upper layer of the received frame,
wherein the entry control information includes entry upper protocol information indicating the protocol of the upper layer of the entered frame, and
wherein the search control unit performs search by comparing the frame upper protocol information of the frame control information to the entry upper protocol information of the entry flag control information.

10. The communication device according to claim 1, further comprising:
a destination information storage unit which stores destination information indicating a destination of the received frame,
a destination control unit which transmits the destination information of the received frame stored in the destination information storage unit according to the entry search information searched from the entry search information storage unit, and
a reception frame determining unit which determines a destination of the received frame based on the destination information transmitted from the destination control unit.

11. The communication device according to claim 10, wherein:
the destination information includes a reception valid flag indicating whether reception of the received frame is permitted or rejected; and
the reception frame determining unit rejects the received frame when the reception valid flag of the destination information indicates that the reception is rejected.

12. A communication device comprising:
an entry search information storage unit to store entry flag information indicating a type of an entered frame and entry search information having entry control information as control information of the entered frame,
a flag generating unit to generate frame flag information indicating a type of a frame received by the communication device based on frame control information of the received frame,
a search key generating unit to generate search key information having all or part of the frame flag information and of the frame control information of the received frame, and
a search control unit to control the entry search information storage unit, compare the frame flag information of the search key information to the entry flag information of the entry search information, and search the entry search information having the corresponding comparison result by comparing the entry control information of the entry search information to the frame control information of the search key information.

13. The communication device according to claim 12, wherein the entry control information is provided with an area as entry upper protocol information indicating a protocol of an upper layer of the entered frame.
